(19) United States
(12) Patent Application Publication
(10) Pub. No.: US 2011/0292877 A1
(43) Pub. Date: Dec. 1, 2011

(54) METHOD FOR CHANGING GAN CONTROLLER WITH WHICH A TERMINAL IS REGISTERED BASED ON LOCATION OF THE TERMINAL WHICH IS MOVING

(76) Inventors: Tae Sun Yeoum, Seoul (KR); Chae Gwon Lim, Seoul (KR); Sung Ho Choi, Gyeonggi-do (KR); Eun Hui Bae, Seoul (KR); Han Na Lim, Seoul (KR)

(21) Appl. No.: 13/132,902

(22) PCT Filed: Dec. 3, 2009
(86) PCT No.: PCT/KR2009/007206

§ 371 Date: Aug. 23, 2011

(30) Foreign Application Priority Data
Dec. 5, 2008 (KR) 10-2008-0122992

(51) Int. Cl. H04W 60/00

(52) U.S. Cl. 370/328

(57) ABSTRACT

The present invention relates to a mobile communication network, and more particularly to a method for the allocation and registration of a suitable generic access network (GAN) controller for the location of a terminal when the terminal moves in the mobile communication network. The mobile communication network comprises: a terminal, which transmits the location information thereof to the mobile communication network, makes a new request for GAN controller information under instructions from the mobile communication network and performs GAN registration again based on the GAN controller information provided from the mobile communication network; a mobility management entity, which receives a location registration request from the terminal, changes WCDMA/GSM location information from the location information of the terminal in the current LTE service area and sends the changed information to the terminal, instructs the terminal to do GAN re-registration and notifies the GAN controller of the change in the location information of the terminal; and the GAN controller, which processes the GAN registration from the terminal and assigns suitable GAN control information for the current location of the terminal.

### BACKGROUND OF THE INVENTION

1. Field of the Invention

The present invention relates to a mobile communication network and, in particular, to a method for assigning and registering with a GAN controller appropriate for the location of the UE on the move within the mobile communication network. That is, the present invention allows the UE to re-register with a GAN controller covering the area where the UE is currently located without involvement of the user when a UE moves out of the service area of the GAN (Generic Access Network) controller within the EPS (Evolved Packet System) network providing voice services with GAN.

2. Description of the Related Art

GAN (generic access network) is a system which is conventionally referred to as UMA (unlicensed mobile access) network. The system supports seamless handover between a cellular network and an IP access network while the UE are transmitting any, both, or nothing of voice and data. That is, the GAN system allows the mobile phone user to take advantages of the fixed broadband network.

The GAN system is an architecture component of the GERAN/UTRAN network and includes a GAN controller. The GAN controller is identical with the base station controller (BSC) of a legacy network in functional view. However, the GAN controller differs from the legacy base station controller in that it is connected to an IP access network at its front end and communicates with the UE via the interface (referred to as Up interface) using dedicated protocol for GAN. The GAN controller is responsible for converting the Up interface messaging to legacy BSC/core network interface protocol for supporting signaling and data communication between UE and network.

FIG. 1 is a diagram illustrating a mobile communication network including the PS (Packet Switched) domain with the GAN controller (Generic Access Network Controller, GANC) and the CS (Circuit Switched) domain with Mobile Switching Center (MSC).

In FIG. 1, the User Equipment (hereinafter, referred to as UE) accesses the voice call service of the Internet Protocol (hereinafter, referred to as IP) network.

Reference numbers 101, 103, and 105 denote the Core Network (Non-Access Stratum) and the Access Network (Access Stratum) evolved from GPRS/UMTS (General Packet Radio Service/Universal Mobile Telecommunications System) as European 2.5 and 3^{rd} generation mobile communication standards.

The enhanced Node B (hereinafter, referred to as eNB) 101 manages radio access.

The Mobility Management Entity (hereinafter, referred to as MME) 103 is responsible for authentication and registration of the UE 110 which attempts to connect to the mobile communication network, processing service request from the UE 110, and guaranteeing the mobility of the UE 110 between eNBs 101.

The Serving Gateway (hereinafter, referred to as SGW) 105 provides the bearer service for transferring the user's service data such as voice information to the eNB 101.

The Packet Data Network Gateway (hereinafter, referred to as PDN GW) 105 assigns an IP address to the UE 110 connected to the mobile communication network and provides IP Connectivity. In the IP network, the PDN GW 105 operates in the same way as IP router.

The SGSN (Serving GPRS Service Node) (not shown) is responsible for authentication and registration of the UE 110 which attempts to connect to the mobile communication network via a GERAN/UTRAN, processing the service request from the UE 110, and guaranteeing the mobility of the UE 110 which moves between BSs or NodeBs.

The Mobile Switching Center (hereinafter, referred to as MSC) 115 is a switchboard providing the UE with circuit switching call processing, mobility management, and GSM service. Here, the service includes all of voice, data, FAX, and SMS.

The Home Subscriber Server (hereinafter, HSS) 109 stores the subscription information and authentication information of the subscriber and retains the address of the MCS 115, SGSN, or MME 103 with which the subscriber is registered in the mobile communication network.

The GAN controller 117 is a device which converts signaling such that the UE can communicate with the mobile communication network via an IP access network rather than the cellular network. The GAN controller 117 is identical with the Base Station Controller (hereinafter, referred to as BSC) of the legacy GERAN network or the Radio Network Controller (hereinafter, referred to as RNC) of the UTRAN network in functional view. However, the GAN controller 117 differs from the BSC/RNC in that the GANC is connected to the UE via IP access network and can communicates with the UE using the dedicated protocol for GAN.

Although the GAN controller 117 is applied to the representative IP access network such as wireless LAN or WiFi, FIG. 1 shows the case where the Evolved Packet System (hereinafter, referred to as EPS) including eNB 101, MME 103, and S-GW/P-GW 105.

The GAN controller 117 includes a Security Gateway (hereinafter, referred to as SEGW) for providing decoded communication channel in order to maintain communication security between the UE 110 and GAN controller 117.

FIG. 2 is a diagram illustrating signaling of the procedure for registration and deregistration of the UE with the GAN controller 117 when the UE moves in or out a GAN service area.

The UE 110 enters the service area of the GAN controller 117 at step 201. The UE 110 makes a query to the DNS server for the IP address of the SEGW 119 for establishing a secure IP tunnel with the SEGW 119 and acquires the IP address at step 203. Next, the UE 110 establishes the secure IP tunnel with the SEGW 119 with the IP address of the SEGW 110 at step 205. Next, the UE 110 acquires the IP address of the GAN controller 117 from the DNS server of the GAN via the secure IP tunnel established with the SEGW 119 at step 207.

The UE 110 sends a GAN registration request message (hereinafter, interchangeably used with the term “GA-RC REGISTER REQUEST message”) to the IP address of the GAN controller 117 so as to request for the GAN service registration at step 209. The GAN registration request message includes a CID (Cell ID), a LAI (Location Area Id), and an IMSI (International Mobile Subscriber Identity).

The GAN controller 117 which has received the GAN registration request message from the UE sends a GAN registration accept message (hereinafter, interchangeably used with the term “GA-RC REGISTER ACCEPT message) to the UE to notify of the completion of the GAN service registration at step 211. At this time, the GA-RE REGISTER ACCEPT message includes the system information of the GAN.

After the completion of the GAN service registration, the UE 110 initiates the Location Area Update process by sending a Location Area Update request message to the MSC 115 via the GAN controller 117 at step 213. Afterward, the incoming call received by the MSC 115 is sent to the UE 110 via the GAN controller 117.

If the UE 110 moves out of the service area of the GAN controller 117, the UE 110 sends a GAN Deregistration message (hereinafter, interchangeably used with the term “GA-RC DEREGISTER message”) to the GAN controller 117 for GAN deregistration at step 217. Once the GSN service is deregistered, the UE 110 initiates Location Area Update process by sending a Location Area Update request message to the MSC via the BSS or RNS for receive an incoming call directly from the MSC 115 by means of A or Iu message of the BSS or RNS at step 219. Afterward, the UE 110 receives the incoming call sent by the MSC 115 via the BSS or RNS.

In case that the GAN service is provided by means of wireless LAN, the GAN service area is confined by the area centering around an access point such that the GAN service is provided within a Hot Zone. Accordingly, when the UE moves out of the Hot Zone, the GAN service is deregistered according to the steps following step 215 of FIG. 2; and when the UE moves in another Hot Zone, the GAN service registration procedure is initiated from the first step. As a consequence, there is no need for the UE 110 to roam between Hot Zones while maintaining the GAN service registration, and the UE switches between GAN controllers as roaming from one to another Hot Zone.

### SUMMARY OF THE INVENTION

### Problem to be Solved

The present invention provides a method and apparatus for maintaining registration with a GAN controller appropriate for the location of the UE in the mobile communication network supporting voice services by means of GAN service especially when the UE registered with a GAN controller moves to an EPS network in a LTE area.

### Means for Solving the Problem

In order to solve the above problems, a method for changing GAN controller in a mobile communication network supporting GAN (Generic Access Network) terminal includes transmitting, a location change of the terminal is detected, a Location Area Update Request (LAU Request) message from the terminal to a GAN controller with which the terminal is registered; determining, at the GAN controller, whether the terminal is necessary to change the GAN controller; and transmitting, when the terminal is necessary to change the GAN controller, a GAN control registration change indication message (GA-RC REGISTER REDIRECT) from the GAN controller to the terminal.

In accordance with another aspect of the present invention, a method for changing GAN controller in a mobile communication system supporting GAN (Generic Access Network) terminal includes instructing, at a mobility management entity when change of location of a terminal is detected, the terminal to relocate the GAN controller (GANG relocation Required); requesting, at the terminal, the GAN controller with which the terminal is registered for GAN registration update (GA-RC REGISTER UPDATE UPLINK); and transmitting, when the request is received, information on a new GAN controller from the registered GAN controller to the terminal.

In accordance with still another aspect of the present invention, a method for changing GAN controller in a mobile communication network supporting GAN (Generic Access Network) terminal includes transmitting, when a mobility management entity detects change of location area of the terminal, a Location Area (LA) change of the terminal to a GAN controller with which the terminal is registered; determining, at the GAN controller, whether the terminal is necessary to change GAN controller; and transmitting, when the terminal is necessary to change GAN controller, a GAN controller registration change instruction (GA-RC REGISTER REDRICT) message from the GAN controller to the terminal.

### Advantageous Effects

According to the present invention, the UE receiving the voice call service with the GAN controller in an LTE service area can receive the incoming call, without notifying the mobile communication network of the current location, when the UE crosses between LTE service area and WCDMA/GSM service area.

### BRIEF DESCRIPTION OF THE DRAWINGS

FIG. 1 is a diagram illustrating a communication network including a PS domain with a GAN controller and a CS domain with a Mobile Switching Center (MCS).

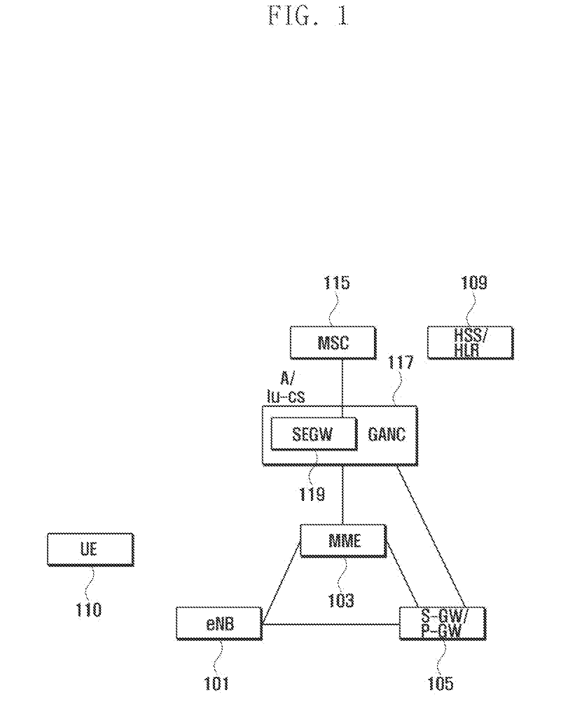

FIG. 2 is a diagram illustrating signaling of the procedure for registration and deregistration of the UE with the GAN controller 117 when the UE moves in or out a GAN service area.

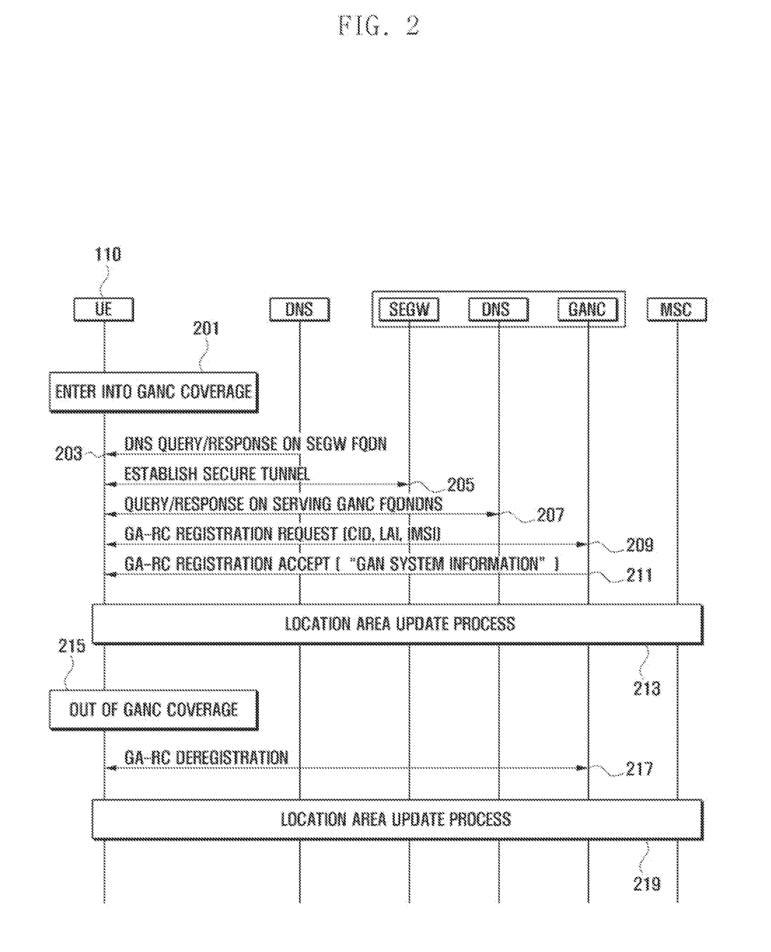

FIG. 3 is a diagram illustrating signaling for registering the UE with a new GAN controller according to the first embodiment of the present invention.

FIG. 4 is a diagram illustrating signaling for registering the UE with a new GAN controller according to the second embodiment of the present invention.

FIG. 5 is a diagram illustrating signaling for registering the UE with a new GAN controller according to the third embodiment of the present invention.

FIG. 6 is a flowchart illustrating operations for the MME to instruct the UE for GAN controller re-registration request according to the first embodiment of the present invention.

FIG. 7 is a flowchart illustrating operations for the MME to instruct the UE for GAN controller re-registration request according to the second embodiment of the present invention.

FIG. 8 is a flowchart illustrating operations for the MME to instruct the UE for GAN controller re-registration request according to the third embodiment of the present invention.

### DETAILED DESCRIPTION OF EXEMPLARY EMBODIMENTS

Exemplary embodiments of the present invention are described with reference to the accompanying drawings in detail. Detailed description of well-known functions and structures incorporated herein may be omitted to avoid obscuring the subject matter of the present invention. The following terms are defined in consideration of functions in the present invention, and the meanings thereof may vary according to the intention of a user or an operator or according to usual practice. Therefore, the definitions of the terms must be interpreted based on the entire content of the present specification.

Although the description is directed to the embodiments of the present invention with an exemplary case of EPS (Evolved Packet System) core network as the core network evolved based on the 3GPP, the procedure for providing the GAN service in the present invention can be applied to any type of mobile communication networks in the same manner.

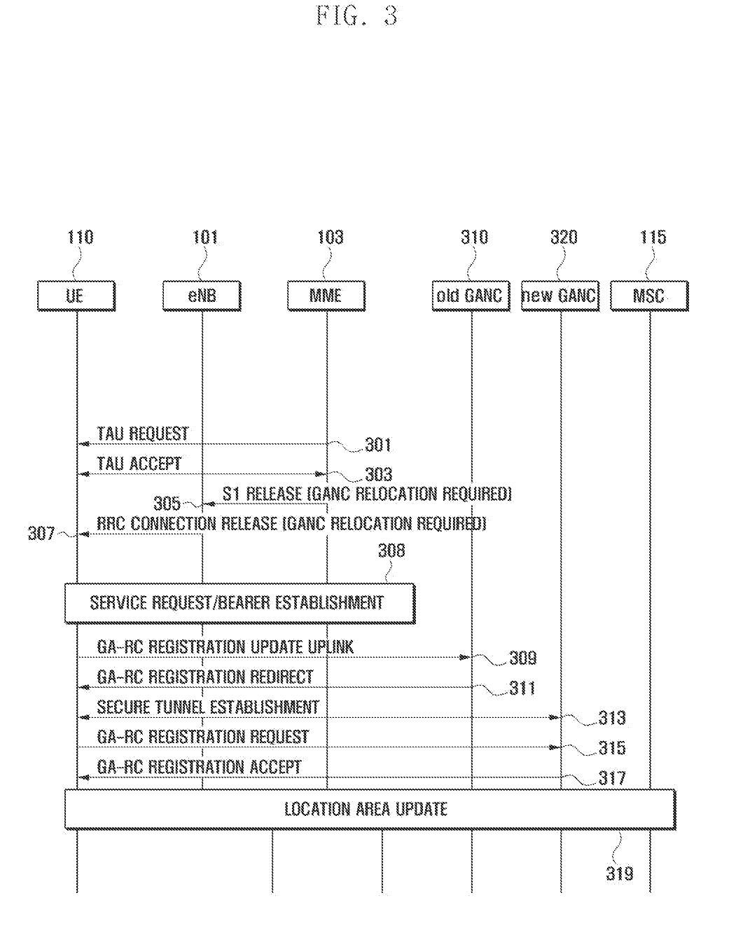

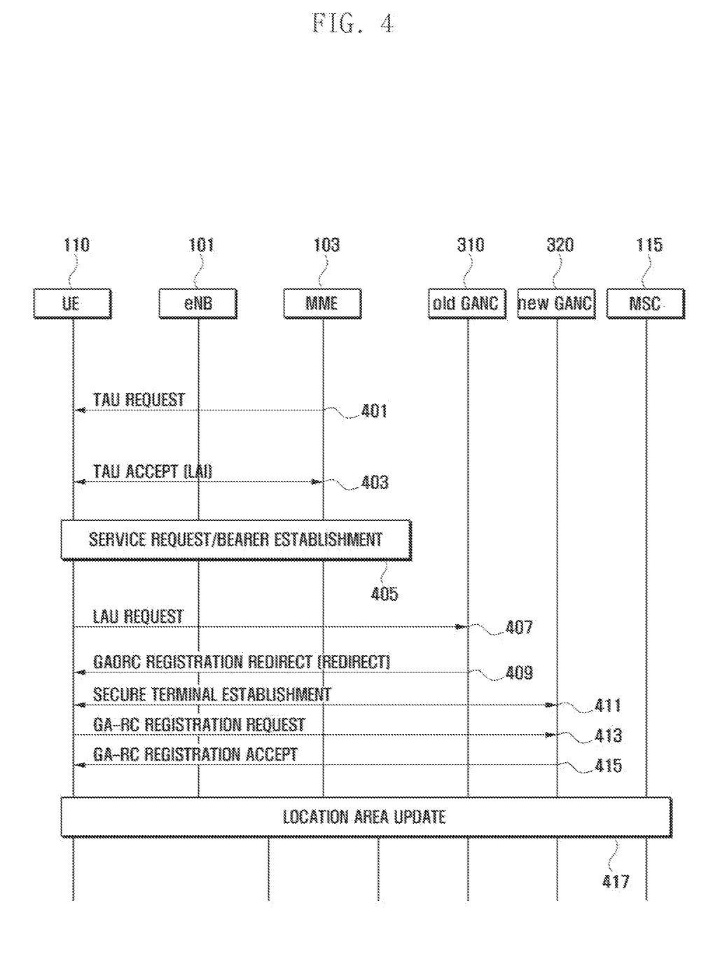

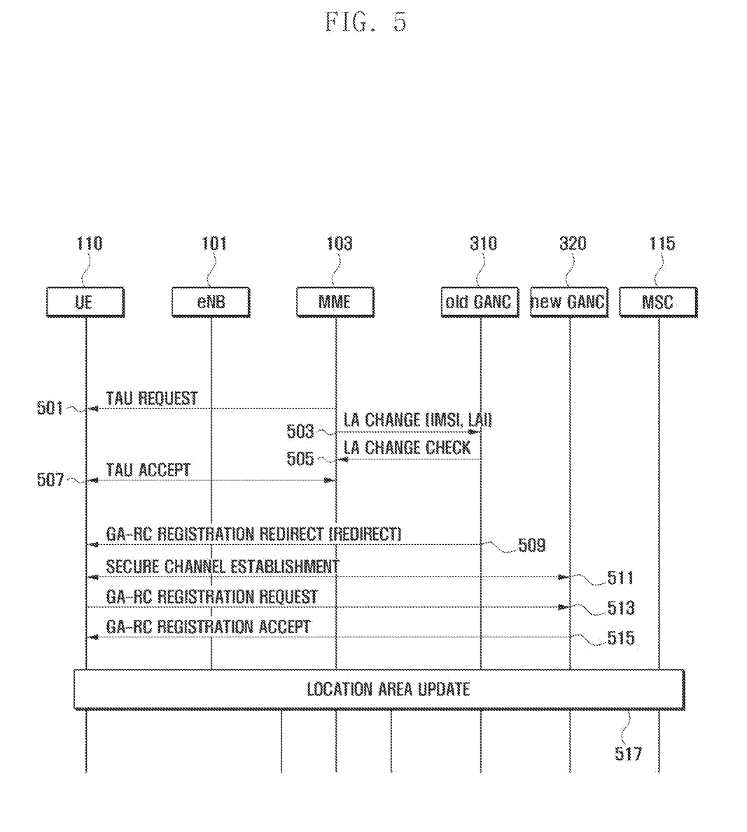

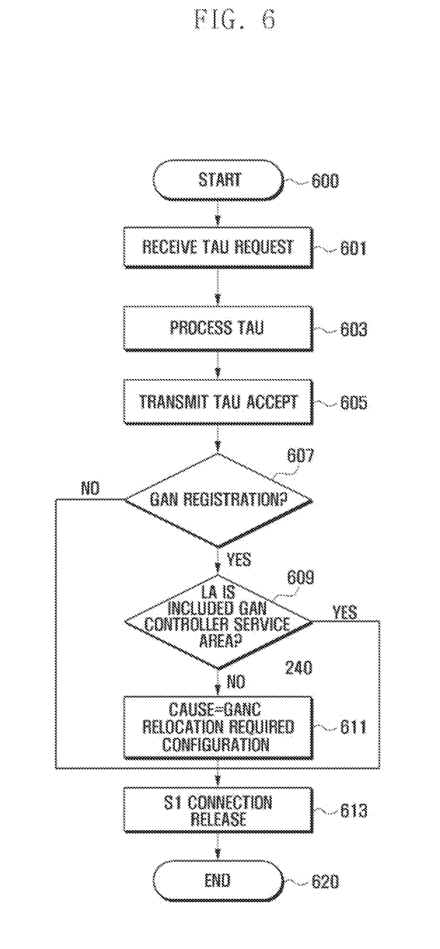

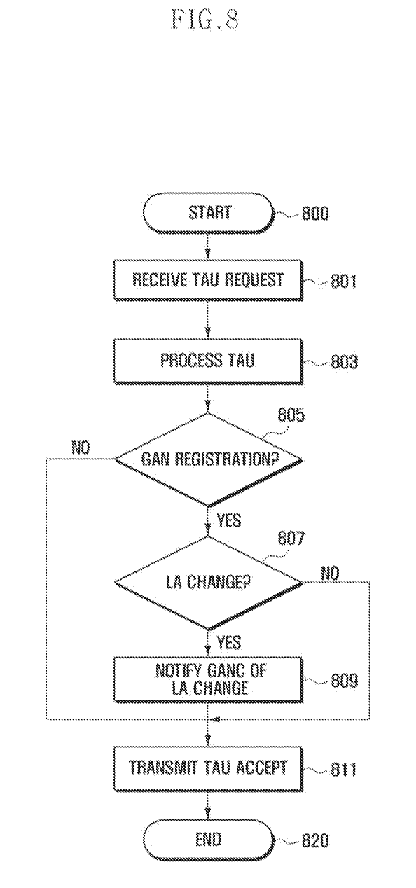

In the following, the description is made of the first to third embodiments differentiated by the method for a UE to register with a new GAN controller. FIGS. 3 and 6 are the drawings for illuminating the first embodiment, FIGS. 4 and 6 for illuminating the second embodiment, and FIGS. 5 and 8 for illustrating the third embodiment.

FIG. 3 is a diagram illustrating signaling for registering the UE 110 with a new GAN controller when the UE 110 registered with a certain GAN controller 310 moves into the service area of an EPS core network and registers its current location with the EPS core network, while moving out of the service area of the current GAN controller 117, according to the first embodiment of the present invention.

The UE 110 moves into a new tracking area (hereinafter, referred to as TA) which is not included in the registered Tracking Area List (hereinafter, referred to as TA list) at step 301 of FIG. 3. The UE 110 sends a Tracking Area Update request message to request the MME 103 for registering the new location.

The MME 103 processes the location registration request of the UE 110 and replies by sending a Tracking Area Update Accept message to the UE 110 at step 303.

The MME 103 determines that the UE 103 registered with a certain GAN 310 moves out of the service area of the currently registered GAN controller 310 at step 305. Here, the MME 103 sends the UE 110 a S1 connection release message with the cause of GAN controller Relocation Required (hereinafter, interchangeably used with the term “GANC Relocation Required”) to request the UE 110 for GAN registration.

For example, the MME 103 manages the mappings between the TA of the UE 110 and the Location Area (hereinafter, referred to as LA) such that, when the UE 110 moves out of the LA served by the GAN controller 310, the MME 103 determines the registration of the UE 110 with a new GAN controller 320.

The eNB 101 sets the cause of the RRC connection release message to “GANC relocation required” so as to notify the UE 110 of the necessity of switching of the GAN controller 310, at step 307.

In order to update the GAN controller registration, the UE 110 sends a Service Request message to the GAN controller 310 to establish a radio bearer for transmitting data and transitions to the active state, at step 308.

The UE 110 sends a GAN registration update uplink message (hereinafter, interchangeably used with the term “GA-RC REGISTER UPDATE UPLINK message”) to the old GAN controller 310 with which the UE is currently registered in order to request for the GAN registration update at step 309. In this case, the UE transmits the LAI (Location Area Identifier) as its location identifier in the GAN registration update uplink message. The old GANC 310 identifies the current location of the UE 110 based on the LAI transmitted by the UE 110 and determines registration with a new GAN controller 320, at step 311.

Next, the old GAN controller 310 sends a GAN registration reconfiguration message (hereinafter, interchangeably used with the term “GA-RC REGISTER REDIRECT message”) containing the information on the new GAN controller 320 to the UE 110. Here, the information on the new GAN controller 320 includes the IP address of the new GAN controller 320.

The UE 110 receives the information on the new GAN controller 320 from the old GAN controller 310 at step 311 and establishes a secure tunnel for secure communication with the new GAN controller 320 at step 313. According to an embodiment of the present invention, the secure tunnel can be an IPSec tunnel as an example.

The UE 110 transmits the GA-RC REGISTER REQUEST message to the new GAN controller 320 via the secure tunnel (established at step 313) to requests for registration with the new GAN controller 320 at step 315. The new GAN controller 320 processes the GAN registration request message of the UE 110 at step 317. The GAN registration is successful, the UE 110 requests the MSC 115 for location registration via the new GAN controller 320 at step 319.

FIG. 4 is a diagram illustrating signaling for registering the UE 110 with a new GAN controller when the UE 110 registered with a certain GAN controller moves into the service area of an EPS core network and registers the current location of the UE 110 with the EPS core network, while moving out of the service area of the current GAN controller, according to the second embodiment of the present invention.

As the UE 110 moves into a new TA which is not included in the registered TA list (Tracking Area List), it sends the Tracking Area Update request to MME 103 for new location registration at step 401. The MME 103 processes the location registration request from the UE 110 and replies by sending a Tracking Area Update Accept message to the UE 110. At this time, the MME 103 sends the LA identity information (LAI) corresponding to the TA in which the UE 110 is located using the information on the mappings between TA and LA which is managed by the MME 103.

The UE 110 receives the LAI transmitted by the MME 103 and compares the received LAI with the LAI received from the GAN controller 310 with which the UE 110 has been registered previously, at step 403.

In case that the two LAIs differ from each other, the UE 110 establishes a radio bearer for transmitting the Location Area Update Request message (LAU request message) to request for the location registration update of the MSC 115, at step 405.

The UE 110 sends the LAU request message to the GAN controller 310 with which the UE 110 is previously registered, at step 407. Upon receipt of the LAU request message, the GAN controller 310 checks that the UE 110 is currently located out of the its service area and determines the necessity of the GAN controller switching. The GAN controller 310 sends the GA0RC REGISTER REDIRECT message to the UE 110 to instruct to switch to the new GAN controller 320. The GA-RC REGISTR REDIRECT message includes the information on the IP address of the new GAN controller 320.

The UE 110 receives the information on the new GAN controller 320 from the old GAN controller 310 at step 409 and establishes a secure tunnel for security communication with the new GAN controller 320 at step 411.

The UE 110 sends the GA-RC REGISTER REQUEST message to the new GAN controller 320 via the secure tunnel established at the previous step to request for the new registration at step 413. The new GAN controller 320 processes the new registration of the UE 110 at step 415. If the new registration is successful, the UE 110 requests the MSC 115 for the location registration again via the new GAN controller 320.

FIG. 5 is a diagram illustrating signaling for registering the UE 110 with a new GAN controller when the UE 110 registered with a certain GAN controller moves into the service area of an EPS core network and registers the current location of the UE 110 with the EPS core network, while moving out of the service area of the current GAN controller, according to the third embodiment of the present invention.

The UE 110 moves into a new TA which is not included in the registered TA list at step 501 of FIG. 5. In this case, the UE 110 sends the Tracking Area Update request to the MME 103.

Next, the MME 103 determines whether the UE 110 is registered with a certain GAN controller. If the UE 110 is registered with a GAN controller, the MME 103 detects the change of the LA where the UE 110 is located using the mapping information between TA and LA under its management and notifies a certain GAN controller 310 of the LA change by sending the Location Area Change message (LA change message) at step 503. At this time, the LA change message includes the LAI acquired by mapping the IMSI (Internal Mobile Subscriber Identity) as the identifier of the UE 110 and TA.

The GAN controller 310 replies by transmitting the location area change ask (LA check ask) message to the MME 103 at step 505.

After completing the location registration of the UE 110, the MME 103 replies by sending the TAU accept message to the UE 110 at step 507.

Meanwhile, the GAN controller 310 receives the LAI information of the UE 110 from the MME and determines that the UE 110 is out of its service area, at step 503. The GAN controller 310 sends the GA-RC REGISTER REDIRECT message to the UE 110 to instruct the UE 110 to update the GAN registration with the new GAN controller 320 at step 509. The GA-RC REGISTER REDRICT message includes the information on the IP address of the new GAN controller 320.

The UE 110 receives the information on the GAN controller from the old GAN controller 310 at step 509 and establishes a secure tunnel for secure communication with the new GAN controller 320.

The UE 110 sends the GA-RC REGISTER REQUEST message to the new GAN controller 320 via the secure tunnel established at the previous step in order to request for new registration at step 513. The new GAN controller 320 processes the new registration request of the UE 110 at step 515. If the new registration is successful, the UE 110 requests the MSC 115 for location registration again via the new GAN controller 320 at step 517.

FIG. 6 is a flowchart illustrating operations for the MME to instruct the UE for the GAN controller re-registration request when the UE registered with a certain GAN controller transmits the TAU request message to the MME, according to the first embodiment of the present invention.

Referring to FIG. 6, the MME 103 receives the TAU request form the UE 110 at step 601. Upon receipt of the TAU request, the MME 103 processes the TAU request at step 603 and sends the UE 110 the TAU response message at step 605.

Next, the MME 103 checks whether the UE 110 is registered with the GAN at step 607 and checks the LA from the current TA of the UE when the UE 110 is registered with the GAN. Next, the MME 103 checks whether the LA is included in the service area of the GAN controller 310 with which the UE is currently registered. The MME 103 can determine whether the checked LA is included in the service area of the GAN controller 310 by using the mapping relationship between the TA of the UE 110 and the LA.

If the LA is included in the service area of the GAN controller 310 or changed, the MME 103 sets the SI connection release cause to GANC relocation request so as to instruct the UE 110 to reconfigure the GAB registration via the RRC release cause at step 611. The MME 103 releases the S1 connection at step 613. Accordingly, the UE 110 can perform registration with the new GAN controller 320 according to the following procedure.

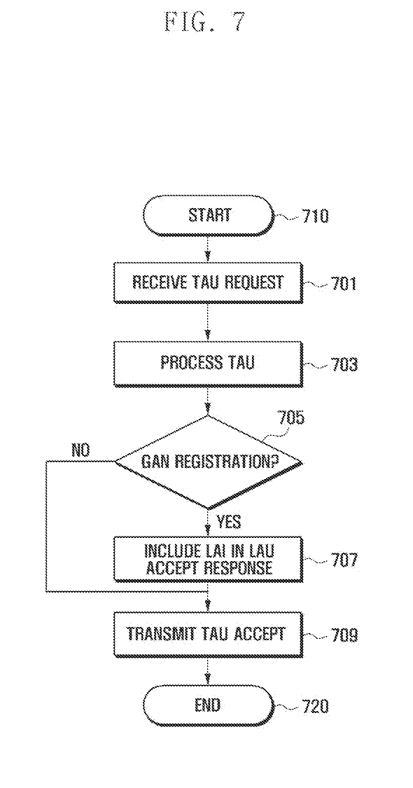

FIG. 7 is a flowchart illustrating operations for the MME to notify the UE of the current LA in response to the TAU request message transmitted by the UE according to the second embodiment of the present invention.

Referring to FIG. 7, the MME 103 receives the TAU request from the UE 110 at step 701 and processes the TAU request at step 703. Next, the MME 103 determines whether the UE 110 is registered with a certain GAN, at step 705. If the UE is registered with a specific GAN, the MME 103 checks the LA using the current TA of the UE and generates the LAI as the location area identifier of the current location of the UE 110 at step 707. Next, the MME 103 adds the generated LAI to the TAU accept response message. The MME 103 sends the TAU accept message to the UE 110 at step 709. The UE 110 can perform registration with the new GAN controller 320 based on the information carried in the TAU accept message.

FIG. 8 is a flowchart illustrating operations for the MME to instruct the UE to perform GAN re-registration by notifying the GAN controller of the change of the LA of the UE when the UE registered with a certain GAN controller has sent the TAU request message to the MME, according to the third embodiment of the present invention.

Referring to FIG. 8, the MME 103 receives the TAU request from the UE 110 at step 801 and processes the TAU request at step 803. The MME 103 determines whether the UE 110 is registered with a GAN, at step 805. If the UE 110 is registered with a GAN, the MME 103 checks the LA from the LA of the UE 110 to determine whether the LA is changed, at step 807. If the LA is changed, the MME 103 sends a LA change message to the GAN controller 301 with which the UE 110 is currently registered. If an LA change acknowledgement message is received from the GAN controller 310 in response to the LA change message, the MME 103 sends a TAU accept response message to the UE 110 at step 811. The UE 110 can perform the procedure for registration with the new GAN controller 320 based on the TAU accept response message afterward.

The embodiments disclosed in the specification and drawings aim only to help understand but not limit the present invention. Meanwhile, persons ordinarily skilled in the art would make modifications in terms of specific embodiments and application scopes without departing from the concepts of the present invention.

1. A method for changing a GAN (Generic Access Network) controller registration in a mobile communication network supporting a terminal, the method comprising:
receiving a Location Area Update Request (LAU Request) message from the terminal to a GAN controller with which the terminal is registered when a location change of the terminal is detected;
determining, at the GAN controller with which the terminal is registered, whether the terminal is necessary to change to a new GAN controller; and
transmitting a GAN control registration change instruction message (GA-RC REGISTER REDIRECT) from the GAN controller with which the terminal is registered to the terminal when the terminal is necessary to change to the new GAN controller.

2. The method of claim 1, wherein determining whether the terminal is necessary to change to a new GAN controller comprises:
comparing location identity information received from a higher layer entity with a location identity information received from the GAN controller with which the terminal is registered; and
determining whether the location of the terminal is changed.

3. The method of claim 1, wherein determining whether the terminal is necessary to change to a new GAN controller comprises judging, when the location of the terminal is out of a service area of the GAN controller with which the terminal is registered, that the terminal is necessary to change to a new GAN controller.

4. The method of claim 1, wherein the GAN controller registration change instruction message comprises address information of the new GAN controller.

5. The method of claim 1, further comprising registering the terminal with the new GAN controller when a GAN registration change instruction request message (GA-RC REGISTER REQUEST) is received from the terminal at the new GAN controller.

6. A method for changing a GAN (Generic Access Network) controller registration in a mobile communication system supporting a terminal, the method comprising:
receiving, at the terminal, a GAN Controller Relocation Required message when a changed of location of the terminal is detected, at a mobility management entity when change of location of a terminal is detected;
requesting, at the terminal, a GAN controller with which the terminal is registered for a GAN registration update; and
receiving, at the terminal, information on a new GAN controller from the GAN controller with which the terminal is registered.

7. The method of claim 6, wherein the GAN Controller Relocation Required message reflects that the mobility management entity has determined that the location of the terminal has changed based on location information transmitted by the terminal.

8. The method of claim 6, wherein the GAN Controller Relocation Required message comprises instructions for the terminal to relocate when the terminal is out of a service area of the GAN controller with which the terminal is registered.

9. The method of claim 6, wherein requesting the GAN controller with which the terminal is registered for a GAN registration update comprises transmitting a location area identifier of the terminal.

10. The method of claim 6, wherein the information on the new GAN controller comprises an address of the new GAN controller.

11. The method of claim 6, further comprising transmitting a GAN controller registration request (GA-RC REGISTER REQUEST) message from the terminal to the new GAN controller to register the terminal with the new GAN controller.

12. A method for changing a GAN (Generic Access Network) controller registration in a mobile communication network supporting a terminal, the method comprising:
receiving a Location Area (LA) change message at a GAN controller with which the terminal is registered;
determining, at the GAN controller with which the terminal is registered, whether the terminal is necessary to change to a new GAN controller; and
transmitting, when the terminal is necessary to change to the new GAN controller, a GAN controller registration change instruction (GA-RC REGISTER REDRICT) message from the GAN controller with to the terminal.

13. The method of claim 12, wherein the Location Area (LA) change message comprises an indication that a change of a location area of the terminal has been detected based on information transmitted by the terminal.

14. The method of claim 12, wherein the Location Area (LA) change message comprises a terminal identifier and a location area identifier of the terminal.

15. The method of claim 12, wherein determining whether the terminal is necessary to change to the new GAN controller comprises determining whether the terminal is out of a service area of the GAN controller with which the terminal is registered.

16. The method of claim 12, wherein the GA-RC REGISTER REDRICT message comprises address information of the new GAN controller.

17. The method of claim 12, further comprising registering the terminal at the new GAN controller when a GAN controller registration change request (GA-RC REGISTER REQUEST) message is received from the terminal.

18. The method of claim 17, further comprising transmitting a GAN controller registration change accept (GA-RC REGISTER ACCEPT) message is transmitted from the new GAN controller to the terminal when the terminal is successfully registered at the new GAN controller.

19. The method of claim 12, further comprising transmitting an LA check message to a mobility management entity in response o receiving the LA change message.

20. The method of claim 12, wherein the GA-RC REGISTER REDRICT message comprises information for securing a secure communication between the terminal and the new GAN controller.
